(19) United States
(12) Patent Application Publication
(10) Pub. No.: US 2010/0306938 A1
(43) Pub. Date: Dec. 9, 2010

(54) MEDICAL IMPLEMENT CLEANING DEVICE WITH FRICTION-BASED FITTING

(75) Inventors: Bobby E. Rogers, San Diego, CA (US); Paul Diperna, San Clemente, CA (US)

Correspondence Address: Mintz Levin Cohn Ferris Glovsky and, 3580 Carmel Mountain Road, Suite 300, San Diego, CA, 92130-6768, US

(73) Assignee: IVERA MEDICAL CORPORATION, San Diego, CA (US)

(21) Appl. No.: 12/791,809

(22) Filed: Jun. 1, 2010

Related U.S. Application Data
(60) Provisional application No. 61/183,039, filed on Jun. 1, 2009.

(51) Int. Cl. B08B 1/00

(52) U.S. Cl. 15/104.93

(57) ABSTRACT

A cleaning device for a medical implement is disclosed. The cleaning device includes a cap having an opening to an inner cavity, the opening being adapted to receive a site of the medical implement. The cleaning device further includes a compressible cleaning material that contains a cleaning agent prior to receipt of the site of the medical implement, i.e. the cleaning material is pre-loaded with the cleaning agent. The compressible cleaning material is at least partially secured in the inner cavity and adapted to swab and clean the site with the cleaning agent. The cap further includes a friction-forming member for creating a friction-based fitting of the cap onto the site of the medical implement.

### CROSS REFERENCE TO RELATED APPLICATIONS

This application claims the benefit of priority under 35 U.S.C. §119 to U.S. Provisional Patent Application Ser. No. 61/183,039, filed on Jun. 1, 2009, entitled, “MEDICAL IMPLEMENT CLEANING DEVICE WITH FRICTION-BASED FITTING”, the entire disclosure of which is incorporated by reference herein.

### BACKGROUND

The present invention relates to cleaning devices, and more particularly to a universal connector cap that cleanses a connector of pathogens or other harmful materials or contaminants and employs friction-based fitting to a connector site or other medical implement.

In the medical field there is often a need to connect tubing to a variety of devices to help with the administration of fluids to a patient. To allow tubing and components from different manufacturers of a variety of devices to connect with one another, a standard connector 100 was developed, as shown in FIGS. 1A and 1B. The standard connector 100 generally consists of a male connector 102 (or “port,” which is used interchangeably herein) being inserted into a female connector 104 whereby friction would keep them together, as shown in FIG. 1A. The taper of the male connector 102 on the left is adapted to closely match the taper of the female connector 104 on the right to create a friction or compression type connection that is fluid tight. For infusion or aspiration of fluids to or from an intravenous or arterial access line or device, i.e. including, without limitation, a catheter, IV set, extension set stopcock, syringe, valve, etc., this type of connector 100 is known as a Luer. The dimensions of Luer connectors can be found in ISO Standards 594-1 and 594-2.

Luers were later improved with threading mechanisms to allow and assist the two connectors to screw together, whereby friction was again the holding force. This threading was merely an enhancement to enable a user to more easily drive the male and female connectors 102 and 104 together.

If a female connector 104 remains open when not connected, there is an increased risk of infections, leakage of fluid and other problems resulting from having open access to the patient. To eliminate this “open” problem, a rubber port 106 can be used for the female connector 104 that can keep the female connector 104 closed until used for injections, as shown in FIG. 1B. The rubber port 106 is typically pierced with a needle, or can be removed to connect the female connector 104 with other tubing.

The female connector 104 was further improved with one of several other features, such as a split septum, biased septum, displaceable piston etc. that can be displaced from a closed position by the male connector 102 when it needed to be out of the way, but which can spring back to the closed position as required. This device was highly desirable because it eliminated the dangerous needle and its closure was automatic. This device is commonly called a needleless adapter, or a Luer Activated Valve (LAV). For instance, the Luer tapered male port on standard syringes can open a fluid path without a needle, through or around the displaced feature on the female side when the two were pressed or screwed together. After the injection of fluids, the syringe was unscrewed/removed. Upon removal, the needle-free feature (whether a biased plug/piston, split septum or other displaceable construct) is, without user interaction, automatically biased back into its normally closed position.

This improvement simplified the administration of fluids by removing needles and reducing open port risks but still necessitated the use of a disinfecting wipe prior to insertion since the outside features would still remain exposed to touch and air contamination.

Without a male feature, the friction that can hold any cap or enclosure to the valve is virtually nonexistent. A minor shaking or unscrewing action will dislodge the cap from the female side. Nearly all currently marketed threaded devices use a “screw” molding process to create the threads, similar to that used with a bolt. Without the addition of another piece, this method of manufacturing does not lend itself to development of a means of retaining a cap in place when the luer tapers are removed. In addition, using a traditional thread configuration is challenging because, despite the existence of the ISO standards, a large variation in thread designs on the female Luers still exists. This variation makes it extremely difficult to design a common solution. Use of the traditional “screw” molding process will likely not solve the problem.

There is a need for a means of preventing the cap from inadvertently being removed without the increased cost and user dissatisfaction of additional parts.

### SUMMARY

This document presents a cleaning device for a medical implement. The cleaning device includes a cap having an opening to an inner cavity, the opening being adapted to receive a site of the medical implement. The cleaning device further includes a compressible cleaning material that contains a cleaning agent prior to receipt of the site of the medical implement, i.e. the cleaning material is pre-loaded with the cleaning agent. The compressible cleaning material is at least partially secured in the inner cavity and adapted to swab and clean the site with the cleaning agent.

The cap further includes a friction-forming member for creating a friction-based fitting of the cap onto the site of the medical implement. Alternatively, the cap further includes a member, preferably protruding from threading at the opening of the inner cavity, that, once the cap is fitted onto the site of the medical implement, inhibits easy removal of the cap until a force exerted on the cap exceeds a certain threshold of force.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIGS. 1A and B illustrate male and female connectors of a Luer type connector.

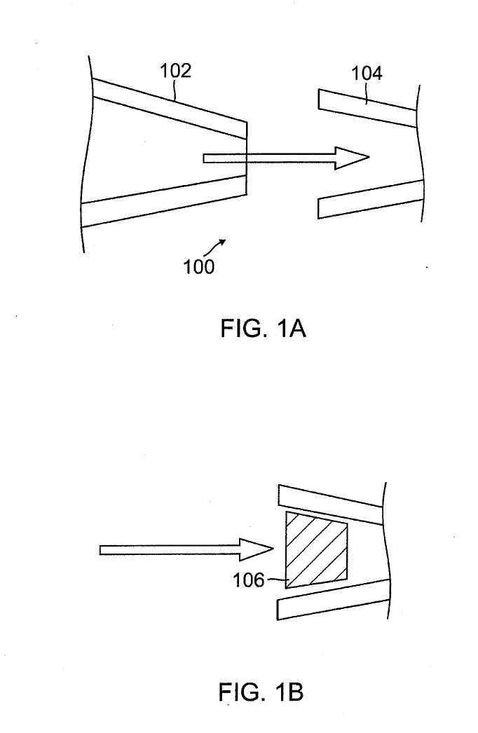

FIGS. 2A and B illustrate a cap for cleaning a female connector of a Luer.

FIGS. 3A and B illustrate a threaded ring portion for the cap, including a friction-forming member.

Like reference symbols in the various drawings indicate like elements.

### DETAILED DESCRIPTION

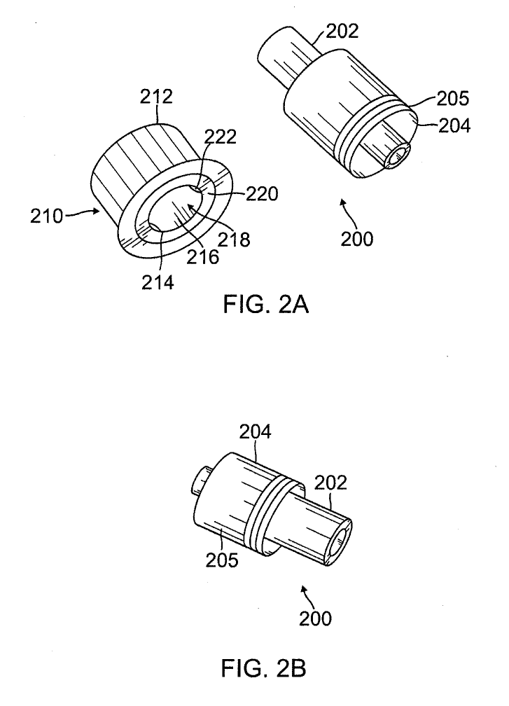

Luer activated valves 200 (LAV's) are typically made of rigid materials such as polycarbonate or acrylic, and as shown in FIGS. 2A and 2B include a male connector 202 and a female connector 204. The female connection of the Luer has threads 205 and a root diameter.

A cleaning device 210 in the form of a cap, is sized and adapted to clean the female connection 204, as exemplified in U.S. patent application Ser. No. 11/705,805, filed Feb. 12, 2007, the contents of which are incorporated herein by reference for all purposes. The cleaning device 210 for medical implements, such as LAVs, includes a cap 212 having an opening 214 to an inner cavity 216. An inner surface of the opening 214 includes one or more threads 222 adapted to receive a site of the medical implement 200. The cleaning device 210 further includes a cleaning material 218 formed of a compressible material that is at least partially secured in the inner cavity 216. The cleaning material 218 contains a cleaning agent that effectively eliminates pathogens and other harmful materials from the site by twisting and fitting the cap onto a site of a medical implement 200, particularly if the cap 210 is fitted onto the site for a period of time. The one or more threads 222 of the cleaning device 210 can be provided by a threaded ring 220 adapted to be fixedly positioned at the inner surface of the opening 214 of the cap 210.

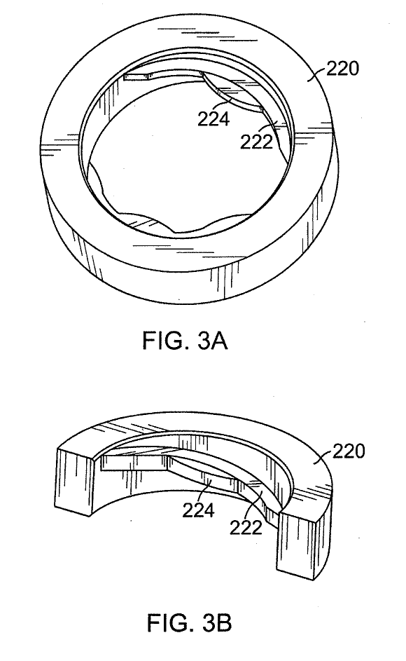

FIG. 3A shows a plan view and FIG. 3B shows a section view of the threaded ring 220 with one or more threads 222. In accordance with some implementations, material is added to the threads 222, such that it creates friction on one or both outer sides of a female connection 204 of a medical implement 200, thereby preventing the cap 210 from unscrewing from the female connection 204 of the medical implement 200. In some implementations, the threads 22 of the cap correspond to an ISO Luer Standard thread. As shown in FIGS. 3A and 3B, the threaded ring 220 incorporates both the thread 222 and at least one protrusion 224 on the threads 222. Each protrusion 224 provides a friction-forming member, and presses against the root diameter of the female connector of the medical implement and it presses on the sides of the thread feature of the female connection, thereby creating friction that holds the 210 in place.

The threading 222 and one or more protrusions 224 cooperate to create a compression fit and to prevent the cap from accidentally coming off the site onto which it is fitted. The implementation shown in FIG. 3A is symmetric: i.e. there is no “up” or “down.” Thus, in an automated assembly operation, orientation of the thread is unimportant, making assembly of the threaded ring 220, and manufacture of the cap 210 simple and efficient.

The threads 222 of the cap 210, and/or the protrusions 224 of added material, can be made of a softer, more compressible material than the cap 210 or the female connector, such as another type of plastic or a rubber, etc. The features pressing on the female side could work in several ways. The added material can press against the more rigid female luer LAV root or body, or threads, to create friction. The added material can also displace plastic to create a single use scenario, where the part pressing on the thread pushes against the outside of the thread 222 or on the sides of the thread 222. The material can further deflect in a variety of ways to make putting on simple, and taking off more difficult.

Additionally the cap 210 can be configured for being pressed on, instead of, or in addition to, being screwed on, with the protrusions 224 of the threads 222 in the form of “flaps” to press against the threads or roots of the female connection 204 of the LAV, similar in function to a star retaining washer. The protruding flaps can be bendable to allow the cap to be forced over the female threads. Once past the threads or a section of threads, the “flaps” would naturally return to their unbent state to prevent the inadvertent removal of the cap 210. To remove the cap 210, it may be possible to unscrew the cap 210 where the flaps find the thread track, but the user could just pull off the cap upon exceeding a certain threshold force to overcome the resistance by the protrusions 224 and/or the threads 222 of the cap 210.

If orientation is an available option, the protrusions 224 can be made to flex more easily in one direction to ease the installation of the cap 210, but then to interfere with inadvertent removal. The same idea can be accomplished with a thread gauge that gets thicker as the cap is screwed on thus allowing the user to get the thread started easily before interference begins.

Alternatively, there is the addition of materials onto a standard cap to interfere with the female Luer root and threads. Examples would be removable thread adhesive, slitting the foil liner and allowing the liner to remain in the way of the two assemblies thereby adding interference but not an additional part.

Another type of interference can be created by using a cap made of sufficiently soft material such as polypropylene, rubber, silicon or polyethylene that is sufficiently flexible that the action of screwing or pressing over the threads effectively deflects the softer material yet it returns quickly to add friction to the removal.

In another implementation, the surface finish of the cap could have small features that effectively create friction such as a knurl or matte finish against the threads or root of the female Luer. In another implementation the cap can be made into an oval such that the cap would tend to become round during the screwing or pressing on action but removed easily when pressed on the long sides to return it to round. Once again, soft flexible materials can be used.

With a slightly out of round (i.e. oval) cap and thread combination, when the cap is placed onto a valve, it conforms to the “circular” shape of the valve. In this way it provides a compressive force on the various dimensions of the valve. Upon removal the cap then returns to its original non-round shape.

In another implementation, the traditional unwind method of molding can be used to manufacture the threads and to create the necessary friction. The threads and/or the root diameter of the cap can be formed to gradually increase in size (the inside diameter decreases away from the opening of the cap) as the part is screwed onto the LAV.

This feature allows users to easily start the screw-on process, then the resistance would increase as the cap is screwed onto the LAV to an appropriate or desired resistance to be overcome to enable removal of the cap. These features can be implemented using an unscrewing process or a simple pull in the plastic tooling. Additionally the press-on features could behave in a similar manner. The features that press against the threads can have multiple layers so the first layer will easily flex past the threads, while other layers can vary (i.e. increase) in thickness or inside diameter to require a harder or a further press on action. The retention feature can be made of a flexible material such as polypropylene, rubber, polyethylene or the like, that is cut to different shapes and can have multiple levels of the material from multiple sheets, or bend to interact at different ways. The cut feature can also have different diameters on each section of the arc in the center allowing the user to hear clicks as they press it on.

Although a few embodiments have been described in detail above, other modifications are possible. Other embodiments may be within the scope of the following claims.

1. A cleaning device for a medical implement, the cleaning device comprising:
a cap having an outer surface including a plurality of vertical ridges on the outer surface, and having an opening to a single inner cavity, the opening being adapted to receive a site of the medical implement, the cap further including threading around a periphery of the single inner cavity, the threading including a friction-forming member that provides a friction-based fitting of the cap onto the site of the medical implement; and
a compressible cleaning material that contains a cleaning agent prior to receipt of the site of the medical implement, the compressible cleaning material at least partially secured in the single inner cavity and adapted to swab and clean the site with the cleaning agent.

2. The cleaning device in accordance with claim 1, wherein the friction-forming member includes at least one protrusion from the threading.

3. The cleaning device in accordance with claim 2, wherein the at least one protrusion is formed of a material that is softer than a material forming the site of the medical implement.

4. The cleaning device in accordance with claim 1, wherein the friction-forming member includes the threading having a gauge that increases inwardly from the opening toward an inside roof of the cap.

5. The cleaning device in accordance with claim 1, wherein the friction forming member includes a decreasing diameter of the threading inwardly from the opening toward an inside roof of the cap.

6. The cleaning device in accordance with claim 1, wherein the opening of the cap is oval-shaped.

7. The cleaning device in accordance with claim 2, wherein the at least one protrusion is formed extending upwardly into the cap, and which is adapted to straighten out when the cap is fitted onto the site of the medical implement.

8. A cleaning system for a female connector of a medical implement, the cleaning system comprising:
a cap having a single inner cavity and an opening to receive at least a portion of the female connector of the medical implement into the single inner cavity;
a threaded ring connected to the single inner cavity at the opening to the cap, and having threads that engage the female connector, the threaded ring further including a friction-forming member for creating a friction-based fitting of the cap onto the female connector; and
a cleaning material in the single inner cavity adapted to provide radial compression against the female connector, the cleaning material containing a cleaning agent prior to receipt of the portion of the female connector of the medical implement.

9. A cleaning device for a medical implement, the cleaning device comprising:
a cap having an outer surface including a plurality of vertical ridges on the outer surface, and having an opening to a single inner cavity, the opening being adapted to receive a site of the medical implement, the cap further including threading around a periphery of the single inner cavity, the threading including a cap removal inhibiting member for inhibiting removal of the cap from the site of the medical implement; and
a compressible cleaning material that contains a cleaning agent prior to receipt of the site of the medical implement, the compressible cleaning material at least partially secured in the single inner cavity and adapted to swab and clean the site with the cleaning agent.
